(19) United States
(12) Patent Application Publication
(10) Pub. No.: US 2001/0039465 A1
(43) Pub. Date: Nov. 8, 2001

(54) Computer control unit for the operation of a water softener

(76) Inventors: Richard M. Schultz, Marengo, IL (US); Stephen Gaynes, Wonderlake, IL (US); John H. Kargenian, Prospect Heights, IL (US)

Correspondence Address: Steven G. Steger, Mayer, Brown & Platt, P.O. Box 2828, Chicago, IL, 60690, US

(21) Appl. No.: 09/808,797

(22) Filed: Mar. 15, 2001

Related U.S. Application Data
(60) Provisional application No. 60/189,515, filed on Mar. 15, 2000.

(51) Int. Cl. G05D 11/00; G05B 11/01

(52) U.S. Cl. 700/282; 700/17; 210/141

(57) ABSTRACT

In one form of the present invention, the operation of reducing hard water to soft is controlled via integrated circuits and software. In combination as a computer control unit, the integrated circuits and software control a valve that supports the cycles used in softening water. The invention reduces the complexity of the setup and operation of a water softener using four simple keys in conjunction with the computer control unit. In addition to these four simple keys, a hidden key is also provided for internal use in manufacturing and servicing operations. The hidden key may have no graphic or identity on the interface panel of the computer control unit, or it may have some graphic not indicative of a key. When depressed along with other keys, this hidden key offers a way to access special operations such as data input and output.

### BACKGROUND

1. Field of Invention

This invention relates generally to the control of various water softening cycles, and in particular to the use of a computer to control the cycles to soften water.

2. Related Art

Water softening systems of the ion exchange type often include a tank having a bed of ion exchange resin, such as a polystyrene resin. The resin material is usually non-soluble and effectively acts as a permanent anion to which exchangeable cations, such as sodium ions (Na⁺) can attach. During the softening process, the hardness-causing ions in the water, such as calcium (Ca⁺⁺) and magnesium (Mg⁺⁺) ions are exchanged with the “soft” sodium ions of the resin bed, thus producing softened water. This exchange occurs because the calcium and magnesium ions have a stronger affinity toward the resin bed than do the sodium ions. After prolonged contact of the resin bed with hard water, however, the ion exchange capacity of the resin bed diminishes, and regeneration of the resin bed must be performed.

Regeneration of the resin bed is normally performed in distinct steps during what is called the regeneration cycle. First, the bed is cleansed during a backwash cycle, where the normal water flow across the resin bed is reversed to expand the resin bed and remove any deposits that may be trapped in the resin bed. Second, a brine solution (i.e., an aqueous solution of sodium chloride or the like) from a separate brine tank is introduced to the resin bed. When the brine contacts the resin bed, the aforementioned ion exchange process is reversed, i.e., the “hard” ions in the resin bed are replaced with “soft” ions from the brine solution. Thereafter, a rinse cycle is normally provided to wash the brine from the resin bed. Lastly, the brine tank is refilled to form brine for the next regeneration cycle.

It is known to utilize mechanical timers to control the various regeneration cycles. Additionally, due to the particular demands placed upon the water softening system, it is often desirable for a user to vary the length of time for each individual regeneration cycle to adjust for various tank sizes and volumes of resin. To accomplish this, mechanical regeneration timers may use movable fingers or dip switches to time the individual regeneration cycles, such as the timer disclosed in U.S. Pat. No. 5,590,687. However, such timers often require disassembly by the user to adjust the individual cycle times. This disassembly usually entails the removal of covers, screws, or other fasteners to access the regeneration cycle time adjustments. Disassembly of this nature is normally awkward and time consuming for users of water softening systems. Thus, there is a need for a computer control unit to control water softener cycle times that allows users and/or technicians to easily and efficiently adjust the individual cycle times without any disassembly of the timer mechanism. Furthermore, it may be desired to keep certain functions contained in the computer control unit from being available to both service providers and end users.

These and other needs will become apparent upon a further reading of the following detailed description taken in conjunction with the drawings.

### SUMMARY OF THE INVENTION

In one form of the invention, the operation of reducing hard water to soft is controlled via integrated circuits and software. In combination as a computer control unit, the integrated circuits and software control a valve that supports the cycles used in softening water. The computer control unit has an interface panel having a keypad overlay covering conductors that are short-circuited when certain areas of the keypad overlay are depressed, as is well-known in the art.

The invention reduces the complexity of the setup and operation of a water softener using four simple keys in conjunction with the computer control unit. In addition to these four simple keys, a hidden key is also provided for internal use in manufacturing and servicing operations. The hidden key may have no graphic or identity on the interface panel of the computer control unit, or it may have some graphic not indicative of a key. When depressed along with other keys, this hidden key offers a way to access special operations such as data input and output.

When the computer control unit is associated with a water softener unit, it is necessary to input the model number of the water softener to the computer control unit. The hidden key is used to program the model number. Once the model number is loaded into the computer control unit, there are certain ranges in each cycle that are programmed according to water conditions. Reducing the number of key strokes in programming the computer control unit increases the ease of programming and setup, thus reducing the likelihood of problems in the input of information. Furthermore, the hidden key allows certain functions of the computer control unit to be available only to service technicians, and not to the end user.

The manufacturer utilizes the hidden key to pre-program the computer control unit with the particular type of valve used in the water softener. Each water softener unit and valve have particular flow controls and tank capacities. At any future time after the initial program of the control unit, the control unit can be reprogrammed to another model number and refifted to a different valve or tank. Thus, the hidden key functions offer flexibility to both manufacturing and field service technicians.

### BRIEF DESCRIPTION OF THE DRAWINGS

FIG. 1 is a perspective view of a computer control interface for a water softener according to a preferred embodiment of the present invention.

FIG. 2 is a block diagram of a water softener control circuit according to a preferred embodiment of the present invention.

FIG. 3 is a flowchart of a Water Softener Control Adaptive Regeneration algorithm according to a preferred embodiment of the present invention.

FIG. 4 is a flowchart of the Manage Salt Reserve function portion of the Adaptive Regeneration algorithm according to a preferred embodiment of the present invention.

FIG. 5 is a flowchart of the Calculate Timing Portion of the Adaptive Regeneration and other than according to a preferred embodiment of the present invention.

FIG. 6 is a circuit diagram of a microcontroller and support circuit of a water softener control circuit according to a preferred embodiment of the present invention.

FIG. 7 is a circuit diagram of a flow meter interface circuit of a water softener control circuit according to a preferred embodiment of the present invention.

FIG. 8 is a circuit diagram of a real-time clock/calendar circuit of a water softener control circuit according to a preferred embodiment of the present invention.

FIG. 9 is a circuit diagram of a valve motor position feedback circuit of a water softener control circuit according to a preferred embodiment of the present invention.

FIG. 10 is a circuit diagram of a regeneration valve motor drive circuit of a water softener control circuit according to a preferred embodiment of the present invention.

FIG. 11 is a circuit diagram of a power supply circuit of a water softener control circuit according to a preferred embodiment of the present invention.

FIG. 12 is a circuit diagram of a power line synchronization circuit of a water softener control circuit according to a preferred embodiment of the present invention.

FIG. 13 is a circuit diagram of a nonvolatile memory circuit of a water softener control circuit according to a preferred embodiment of the present invention.

FIG. 14 is a circuit diagram of a keypad switch and interface circuit of a water softener control circuit according to a preferred embodiment of the present invention.

FIG. 15 is a circuit diagram of an audio annunciator drive circuit of a water softener control circuit according to a preferred embodiment of the present invention.

FIG. 16 is a circuit diagram of an LED display module of a water softener control circuit according to a preferred embodiment of the present invention.

### DETAILED DESCRIPTION OF THE PREFERRED EMBODIMENT

While the present invention is capable of embodiment in various forms, there is shown in the drawings and will be hereinafter described a presently preferred embodiment with the understanding that the present disclosure is to be considered as an exemplification of the invention, and is not intended to limit the invention to the specific embodiment illustrated in the drawings and described herein.

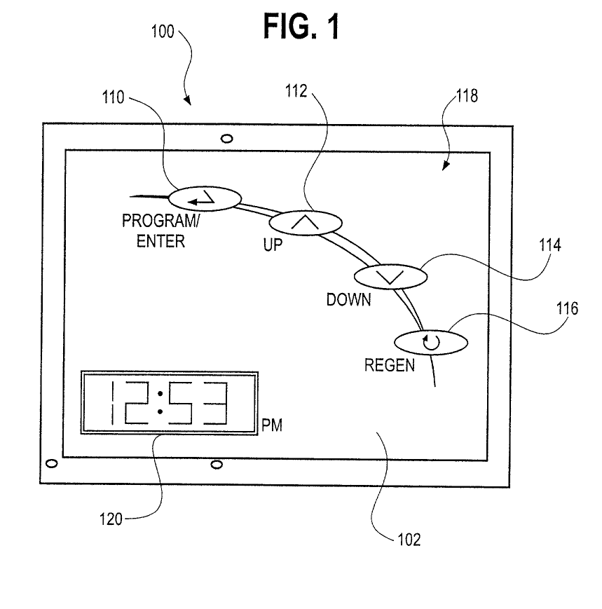

For purposes of illustration, and not limitation, a computer control interface panel for a water softener, designated generally as reference numeral 100, is shown in FIG. 1.

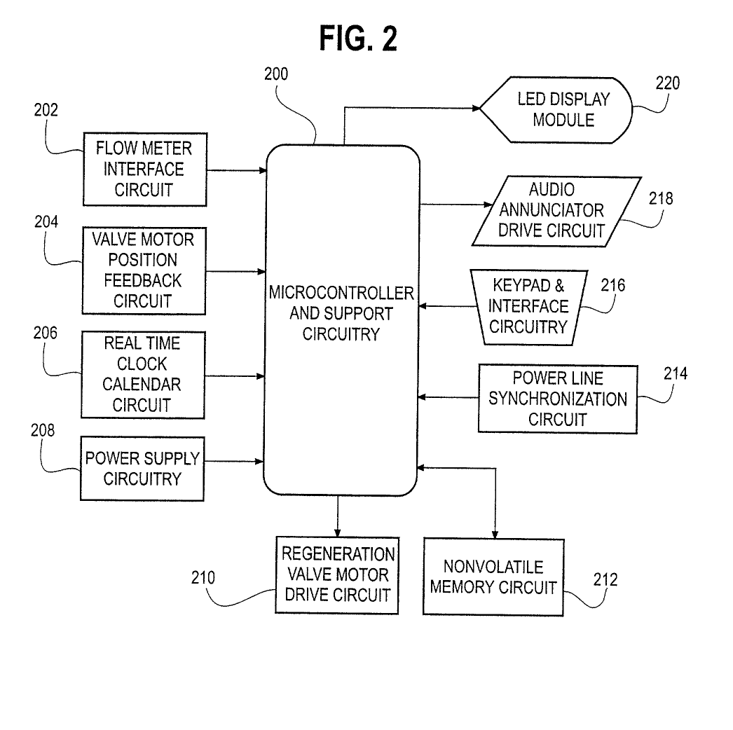

This computer control interface panel 100 allows the user to input information to the 10 computer control unit via various keys. In a preferred embodiment, the interface panel 100 comprises a keypad overlay 102 covering switches (discussed in more detail with respect to FIG. 14) that are short-circuited when various locations, graphically represented as keys, of the keypad overlay 102 are depressed. The keypad overlay 102 is attached to a printed circuit board with adhesive or other type of connection, such as screws. Other types of input devices, such as buttons or knobs, may be used instead of a keypad overlay. The printed circuit board is populated with integrated circuits that comprise the computer control unit that controls a valve to support the cycles used in softening water. The operation and construction of the computer control unit is described in more detail below with respect to FIGS. 2 through 16.

The functions and operation of the computer control unit according to a preferred embodiment of the present invention will now be described with continued reference to FIG. 1. The computer control unit reduces the complexity of set up and operation of a water softener using four simple keys 110, 112, 114 and 116, shown graphically on the keypad overlay 102. The first key shown graphically on the interface panel 100 is the program/enter key 110, the second key is the up key 112, the third key is the down key 114, and the fourth key is the regen key 116.

In addition to these four simple keys, a hidden key 118 is also provided for internal use in manufacturing and servicing operations. In the preferred embodiment, the hidden key 118 has a graphic representation, such as a golden rain drop, however, the hidden key 118 may have no graphic or identity on the keypad overlay 102. When depressed along with other keys, this hidden key 118 offers a way to access special operations such as data input and output, as described further below. Finally, the interface panel 100 also includes an LED display screen 120, the control and operation of which are well known in the art.

The program/enter key 110 is used as an “enter” key or a “scroll” key during operation of the computer control unit. The program/enter key 110 allows the end user to access various functions of the computer control unit by repeatedly pressing the program/enter key 110 to scroll through the functions, which are shown on the LED display screen 120. In the preferred embodiment, there are four functions that the end user can access using the program/enter key 110: Present Time Adjust, designated by “P” on the LED display screen 120; Hour of Regeneration, designated by “h” on the LED display screen 120; Salt Level Adjust, designated by “S” on the LED display screen 120; and Low Salt Alarm, designated by “A” on the LED display screen 120.

To set or change the time of day using the Present Time Adjust function, the program/enter key 110 is pressed once. The LED display screen 120 displays “P”, then the computer control unit displays the time, allowing the user to adjust the time using the up key 112 and/or the down key 114. When either the up key 112 or the down key 114 is pressed with multiple, individual depressions, the time is adjusted by one minute at a time. However, when either the up key 112 or the down key 114 are pushed and held, the computer control unit enters a fast scroll mode, and the time is adjusted by ten minutes at a time. After the proper time is input using the up key 112 and/or the down key 114, the program/enter key 110 is again depressed so that the computer control unit accepts the new time. If the program/enter key 110 is not depressed within five minutes, the computer control unit will automatically enter the new time.

To set or change the time of regeneration, the program/enter key 110 is pressed twice. The first pressing of the program/enter key 110 enters the computer control unit into the Present Time Adjust function, and “P” is displayed on the LED display screen 120. The second pressing of the program/enter key 110 enters the computer control unit into the Hour of Regeneration function, and “h” is displayed on the LED display screen 120. After a predetermined amount of time, the computer control unit displays the time and prompts the user to enter the hour of regeneration desired. The up key 112 and/or the down key 114 are used to scroll through the time as described above with respect to the Present Time Adjust function, selecting the time for regeneration to occur. After the proper time for regeneration is input using the up key 112 and/or the down key 114, the program/enter key 110 is again depressed so that the computer control unit accepts the new time.

To adjust the amount of salt pounds in the brine tank, the program/enter key 110 is pressed three times. The first pressing of the program/enter key 110 enters the computer control unit into the Present Time Adjust function, and “P” is displayed on the LED display screen 120. The second pressing of the program/enter key 110 enters the computer control unit into the Hour of Regeneration function, and “h” is displayed on the LED display screen 120. The third pressing of the program/enter key 110 enters the computer control unit into the Salt Level Adjust, and “S” is displayed on the LED display screen 120. After a predetermined amount of time, the computer control unit displays the level of salt and prompts the user to enter the level of salt that is in the brine tank.

The up key 112 and/or the down key 114 are used to scroll through the salt levels in the same way that time is adjusted as described above with respect to the Present Time Adjust function. After the level of salt is input using the up key 112 and/or the down key 114, the program/enter key 110 is again depressed so that the computer control unit accepts the new level of salt.

In setting the salt level, the level indicators on conventional water softener tanks can be used in the preferred embodiment of the present invention. There are generally two scales on a brine tank of a water softener, one for block salt (designated by levels 1-4) and the other for solar/rock salt (designated by levels 1-5). Each level represents 50 pounds of salt, thus the level of salt shown on the scales after salt is added to the water softener is what is input to the computer control unit in the Salt Level Adjust function.

The computer control unit includes a low salt alarm that sounds when the salt in the brine tank becomes low. To adjust the time that the Low Salt Alarm sounds, the program/enter key 110 is pressed four times. The first pressing of the program/enter key 110 enters the computer control unit into the Present Time Adjust function, and “P” is displayed on the LED display screen 120. The second pressing of the program/enter key 110 enters the computer control unit into the Hour of Regeneration function, and “h” is displayed on the LED display screen 120. The third pressing of the program/enter key 110 enters the computer control unit into the Salt Level Adjust, and “S” is displayed on the LED display screen 120. The fourth pressing of the program/enter key 110 enters the computer control unit into the Low Salt Alarm function, and “A” is displayed on the LED display screen 120. After a predetermined amount of time, the computer control unit displays the time that the low salt alarm will sound and prompts the user to enter the a time when the user wishes the low salt alarm to sound. The up key 112 and/or the down key 114 are used to scroll through the low salt alarm times in the same way that time is adjusted as described above with respect to the Present Time Adjust function. After the time of the low salt alarm is input using the up key 112 and/or the down key 114, the program/enter key 110 is again depressed so that the computer control unit accepts the new time. In this way, the user can set the time for the low salt alarm to sound so that the user will hear the alarm (i.e. in the evening when the user is at home), or the user can choose to disable the alarm completely.

The computer control unit allows for the manual initiation of the regeneration cycle of the water softener. For example, after reloading the brine tank with salt, the user may wish to regenerate the water softener immediately instead of waiting for the next scheduled regeneration time. In another example, if the user anticipates imminent use of a large quantity of water and does not want to run out of soft water, the regeneration cycle is manually initiated. To manually initiate regeneration, the user simply presses the regen key 116. The computer control unit will then perform regeneration in the same way as in scheduled regenerations.

In the preferred embodiment, the above-described functions are available to the end user using the interface panel 100 of the computer control unit. However, a number of other functions are available to the manufacturer and/or service/repair technicians using the hidden key 118. By holding the hidden key 118 and using the program/enter key 110 to scroll through functions as described above, the manufacturer or service/repair technician can access unit specific variables and diagnostics functions. These additional functions are designated on the LED display screen 120 as follows:

(1) H—Hardness of Inlet Water

(2) C—Cuft Fill

(3) SC—Starting Capacity

(4) u—Gallons/Liters Currently Used

(5) L—Gallons/Liters Used During Last Regeneration

(6) HSL—Hours Elapsed Since Last Regeneration

(7) PSL—Pounds of Salt Used During Last Regeneration

(8) nOr—Number of Regenerations

(9) rO—Regeneration Override

(10) dP—Default Programming

(11) r—Reset Manually Adjusted Cycle Times

(12) dIS—Display Toggle US/Metric

The Hidden Key 118 allows the manufacturer and/or the service/repair technician to scroll through the four end user functions as well as the 12 functions listed above, which will be described in more detail below.

The first function accessible through the hidden key is the Hardness of Inlet Water function. The hardness of water is unique to individual locations and is based on several parameters. The two most common parameters are the type of water delivery system (i.e., well or city) and the geographic location. The hardness of water at individual locations must be determined by the dealer through a water analysis as is well know in the art, and should be set at the time of installation of the water softener. The hardness of the water rarely changes for an individual location, but if it does change, the water softener must be adjusted in the field to reflect the change in hardness of the water.

To adjust the hardness of the water, the hidden key 118 is held in a depressed position while the program/enter key is repeatedly pressed to scroll through the various functions until “H” appears on the LED display screen 120. The computer will display the hardness value of the water in grains and prompt for entry of a new hardness value. The up key 112 and/or the down key 114 are used to scroll through the hardness levels in the same way that time is adjusted as described above with respect to the Present Time Adjust function. After the hardness level is input using the up key 112 and/or the down key 114, the program/enter key 110 is again depressed so that the computer control unit accepts the new hardness level.

The next function accessible using the hidden key 118 is the Cuft Fill (Cubic Foot Fill) function. The capacity of the unit is specific to the size tank of the water softener and the amount of media present and never needs readjusting. This setting is entered by the dealer at the time of installation and will never need changing.

To adjust the media volume capacity setting, the hidden key 118 is held in a depressed position while the program/enter key is repeatedly pressed to scroll through the various functions until “C” appears on the LED display screen 120. The computer control unit will display the current media volume capacity and prompt for entry of the new media volume capacity. The up key 112 and/or the down key 114 are used to scroll through the media volume capacity levels in the same way that time is adjusted as described above with respect to the Present Time Adjust function. After the media volume capacity level is input using the up key 112 and/or the down key 114, the program/enter key 110 is again depressed so that the computer control unit accepts the new media volume capacity level.

The next function accessible through the operation of the hidden key is the Starting Capacity Adjust function. The computer control unit has the capability of changing the amount of gallons used before it performs automatic regeneration. This allows the unit to use more or less of the bed's capacity between regenerations depending on the desired salt use, water consumption, and water quality.

To adjust the starting capacity setting, the hidden key 118 is held in a depressed position while the program/enter key is repeatedly pressed to scroll through the various functions until “SC” appears on the LED display screen 120. The computer control unit will display the current starting capacity and prompt for entry of the new starting capacity. The up key 112 and/or the down key 114 are used to scroll through the preset choices of 33%, 60%, 70% and 80% in the same way that time is adjusted as described above with respect to the Present Time Adjust function. After the starting capacity is input using the up key 112 and/or the down key 114, the program/enter key 110 is again depressed so that the computer control unit accepts the new starting capacity level.

The next function accessible through the operation of the hidden key is the Gallons/Liters Currently Used monitoring function. This function can be used for diagnostics purposes. To see the gallons used during the current service run, the hidden key 118 is pressed and held and the program/enter key 110 is pressed repeatedly until “u” appears on the LED display screen 120. The computer control unit will then display the gallon count used during the current service run. This feature also allows the LED display screen 120 to display the advancing gallons count during use of the water softener. When the desired information is received from the Gallons Currently Used monitoring feature, the program/enter key is pressed to return to the service mode.

The Gallons Currently Used function also allows for the adjustment or presetting of a gallon count for diagnostic purposes only. To make such an adjustment, when the Gallons Currently Used is displayed on the LED display screen as described above, the hidden key 118 is depressed along with the up key 112 and/or the down key 114 to alter the gallon count. Thus, a technician can alter the gallon count to test the functionality of the computer under differing gallon counts without actually having to run water through the system.

The next function accessible through the operation of the hidden key is the Gallons/Liters Used During Last Regeneration monitoring function. This function can be used for diagnostics purposes. To check how many gallons went through the water softener unit during the one service run prior to the last regeneration, the hidden key 118 is pressed and held and the program/enter key 110 is pressed repeatedly until “L” appears on the LED display screen 120. The computer control unit will then display the last gallon count prior to the last regeneration. When the desired information is received from the Gallons/Liters Used During Last Regeneration monitoring feature, the program/enter key is pressed to return to the service mode.

The next function accessible through the operation of the hidden key is the Hours Elapsed Since Last Regeneration monitoring function. This function can be used for diagnostics purposes. To check how many hours have elapsed since the last regeneration, the hidden key 118 is pressed and held and the program/enter key 110 is pressed repeatedly until “HSL” appears on the LED display screen 120. The computer control unit will then display the hours since the last regeneration. The value displayed in this function cannot be altered, as it is for diagnostic purposes only. When the desired information is received from the Hours Elapsed Since Last Regeneration monitoring feature, the program/enter key is pressed to return to the service mode.

The next function accessible through the operation of the hidden key is the Pounds of Salt Used During Last Regeneration monitoring function. This function can be used for diagnostics purposes. To use this diagnostic function, the service technician depresses and holds the hidden key 118 and presses the program/enter key 110 repeatedly until “PSL” appears on the LED display screen 120. The computer control unit will then display the pounds of salt used during the last regeneration. The value displayed in this function cannot be altered, as it is for diagnostic purposes only. When the desired information is received from the Pounds of Salt Used During Last Regeneration monitoring feature, the program/enter key is pressed to return to the service mode.

The next function accessible through the operation of the hidden key is the Number of Regenerations monitoring function. This function can be used for diagnostics purposes. To use this diagnostic function, the service technician depresses and holds the hidden key 118 and presses the program/enter key 110 repeatedly until “nOr” appears on the LED display screen 120. The computer control unit will then display the number of regenerations the water softener unit has performed over its lifetime. The value displayed in this function cannot be altered, as it is for diagnostic purposes only. When the desired information is received from the Number of Regenerations monitoring feature, the program/enter key is pressed to return to the service mode.

The next function accessible through the operation of the hidden key is the Regeneration Override function. The Regeneration Override function includes two separate modes of operation, 96 mode (96) or disable (OFF) mode. The 96 mode causes the water softener to regenerate if 96 hours have passed without any regeneration (or if no water has been used within the previous 96 hours). This function asked as a manual regeneration so long as the 96 hour window described above has expired. The disable mode disables the regeneration function so that the unit will not regenerate. This can be used if the user is away for a long period of time and water will not be used, the disable mode prevents bacteria from growing due to stagnant water.

The next function accessible through the operation of the hidden key is the Default Programming function. Using this function, a technician is able to set the water softener up for the resin characteristics that are being used in the water softener. To reset the settings based on the resin characteristics and certain constants and variables stored in the memory of the computer control unit using the Default Programming function, the hidden key 118 is held in a depressed position while the program/enter key is repeatedly pressed to scroll-through the various functions until “dP” appears on the LED display screen 120. The computer control unit will scroll through various settings as the up key 112 and/or the down key 114 are depressed. The time displayed in the cycle periods are determined through a mass routine. This option will automatically set the refill rate, backwash rate, draw rate, slow rinse rate and fast rinse rate to predetermined values for the particular resin being used. After the desired default setting is input using the up key 112 and/or the down key 114, the program/enter key 110 is again depressed so that the computer control unit accepts the default values.

The next function accessible through the operation of the hidden key is the Reset Manually Adjusted Cycle Times function. To reset any manually adjusted cycle times, the hidden key 118 is held in a depressed position while the program/enter key is repeatedly pressed to scroll through the various functions until “r” appears on the LED display screen 120. The computer control unit will prompt for use of the up key 112 and/or the down key 114 to select the option of resetting any manually adjusted individual cycle times. After the choice is made to either reset all settings, or to retain manually adjusted cycle times, using the up key 112 and/or the down key 114, the program/enter key 110 is again depressed so that the computer control unit accepts the rest choice.

The computer control unit can be manually advanced through each regeneration cycles by using the hidden key 118 in conjunction with the regen key 116. By pressing the hidden key 118 at the same time as the regen key 116, the time remaining in the current regeneration cycle is set to zero, and the computer control unit advances to the next sequential cycle. Thus, each depression of the regen button 116 while the hidden key 118 is pressed manually advances the computer control unit through each successive regeneration step.

The final function in the preferred embodiment accessible through the operation of the hidden key is the Display Toggle US/Metric function. To toggle between U.S. and metric modes, the hidden key 118 is held in a depressed position while the program/enter key is repeatedly pressed to scroll through the various functions until “dlS” appears on the LED display screen 120. The computer control unit will prompt for use of the up key 112 and/or the down key 114 to select the units to be used. When U.S. display mode is chosen, the following units are used: gallons, 12-hour clock, hardness in grains/gallon. When metric units are chosen, the following units are used:

liters, 24-hour clock, hardness in parts per million. The conversion factors used in adjusting between the two unit settings are: 1 gallon=0.26417 liters, 12:00 am=24:00 hours, and 1 grain/gallon=17.1 parts per million. After the choice of units is made using the up key 112 and/or the down key 114, the program/enter key 110 is again depressed so that the computer control unit accepts the choice of units.

The computer control unit automatically determines the timing scheme needed for each cycle of the regeneration process, based on information entered and monitored water usage, to effectively and efficiently regenerate a water softening unit. The end user of the water softener does not need to enter additional information or make adjustments to the settings. However, the computer control unit of the present invention allows any or all of the individual cycle times to be adjusted for any particular application. This allows for the streamlined use of a water softener for a particular application for maximum efficiency.

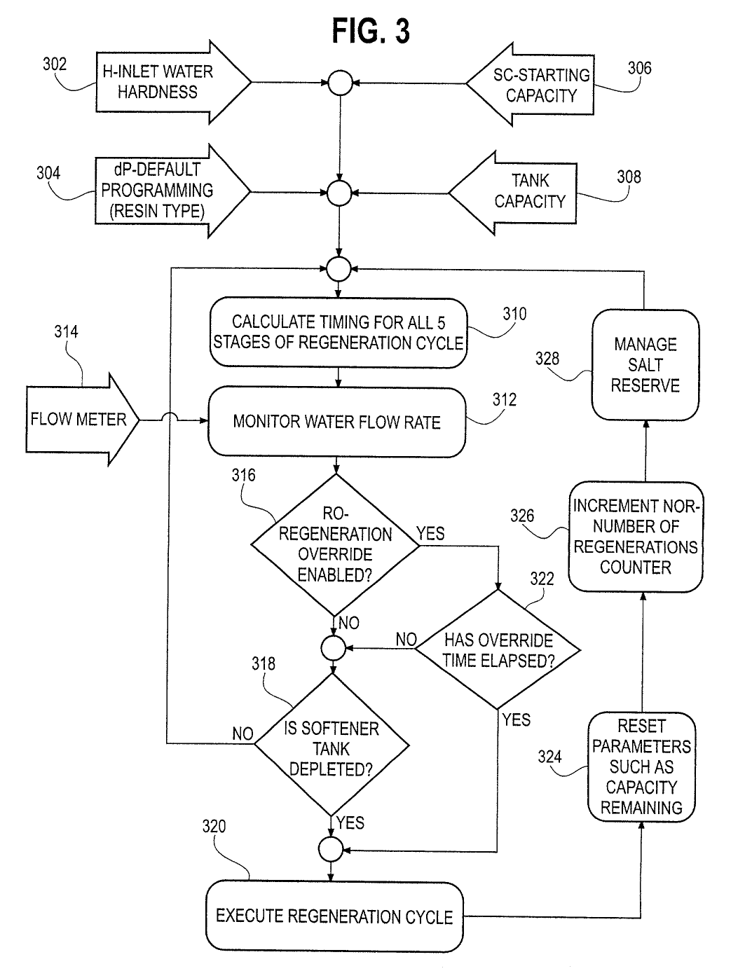

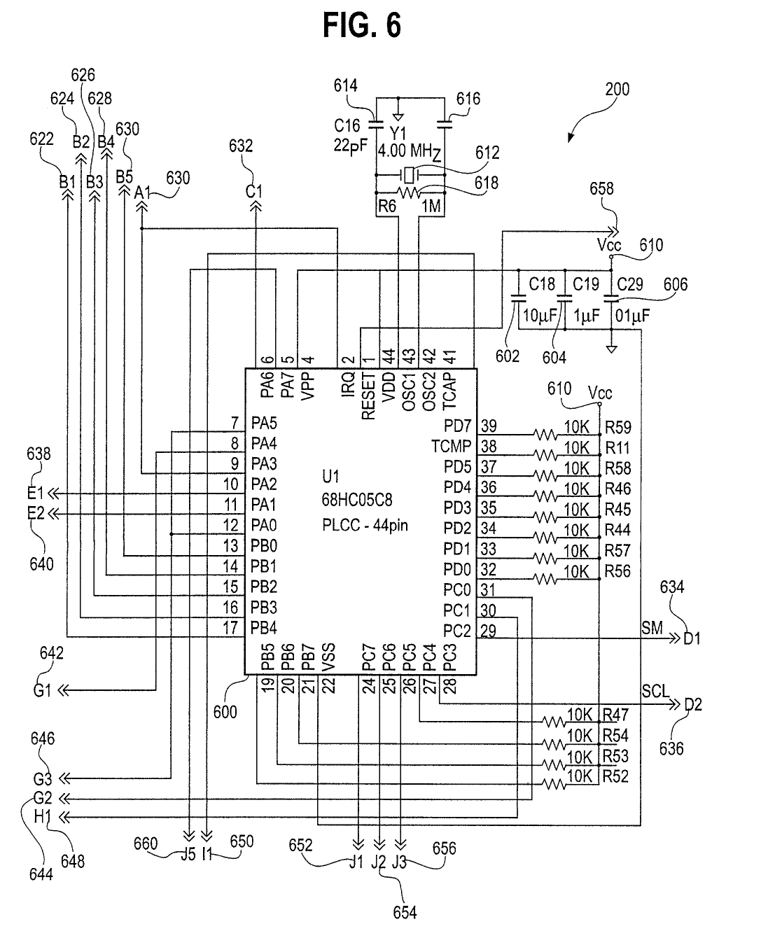

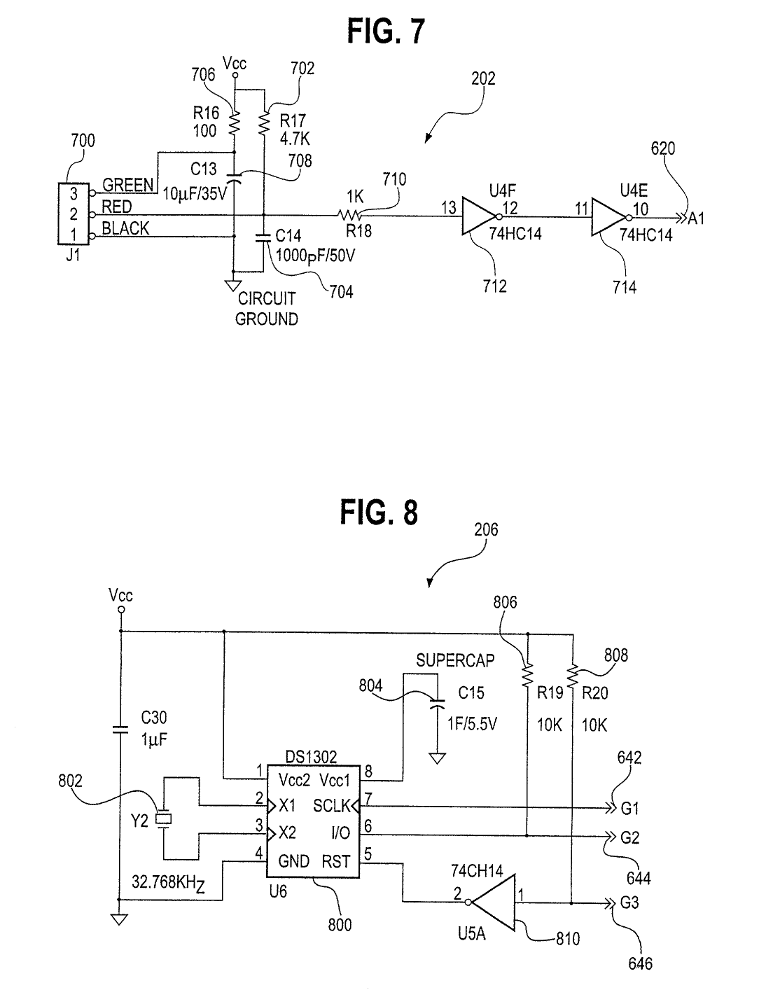

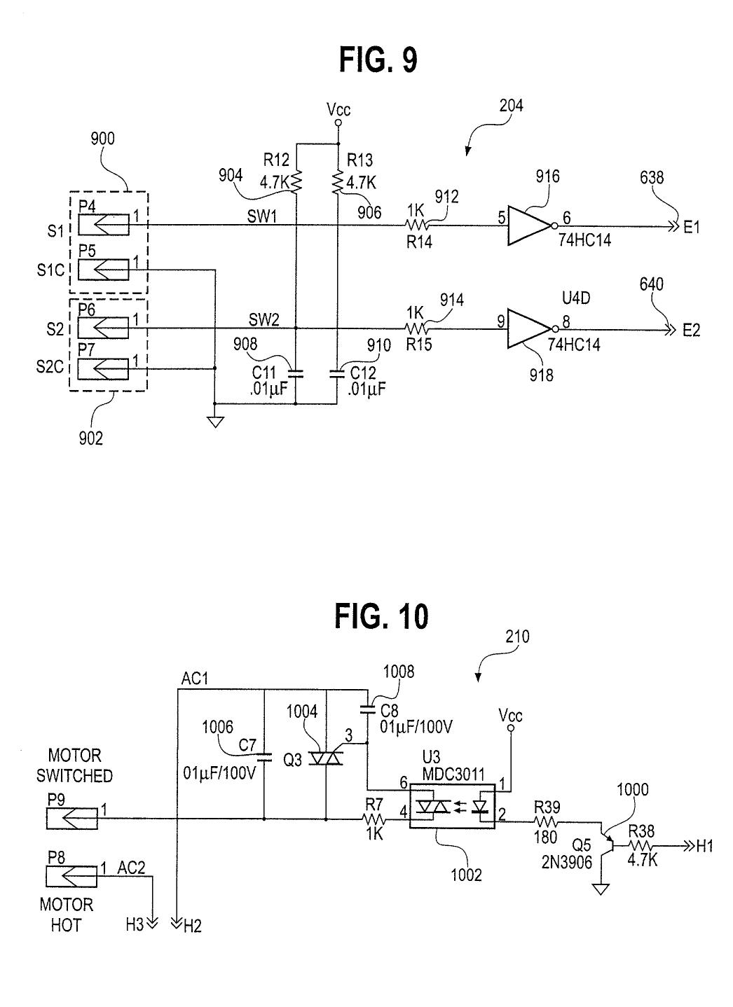

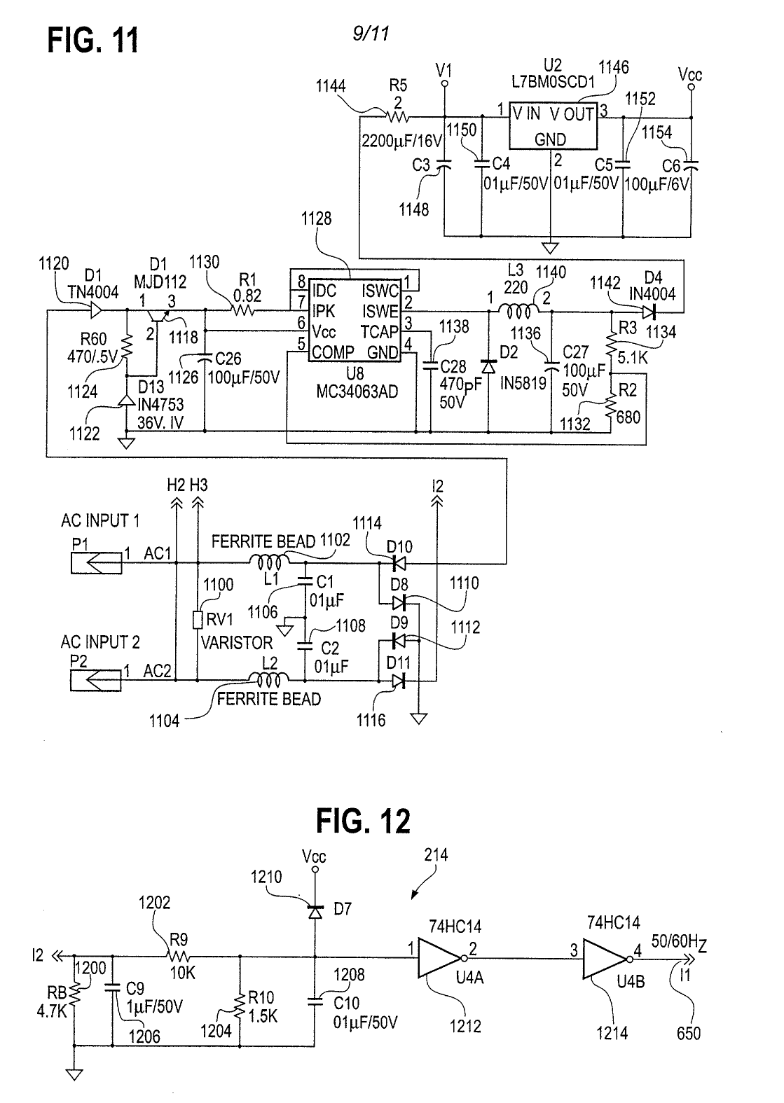

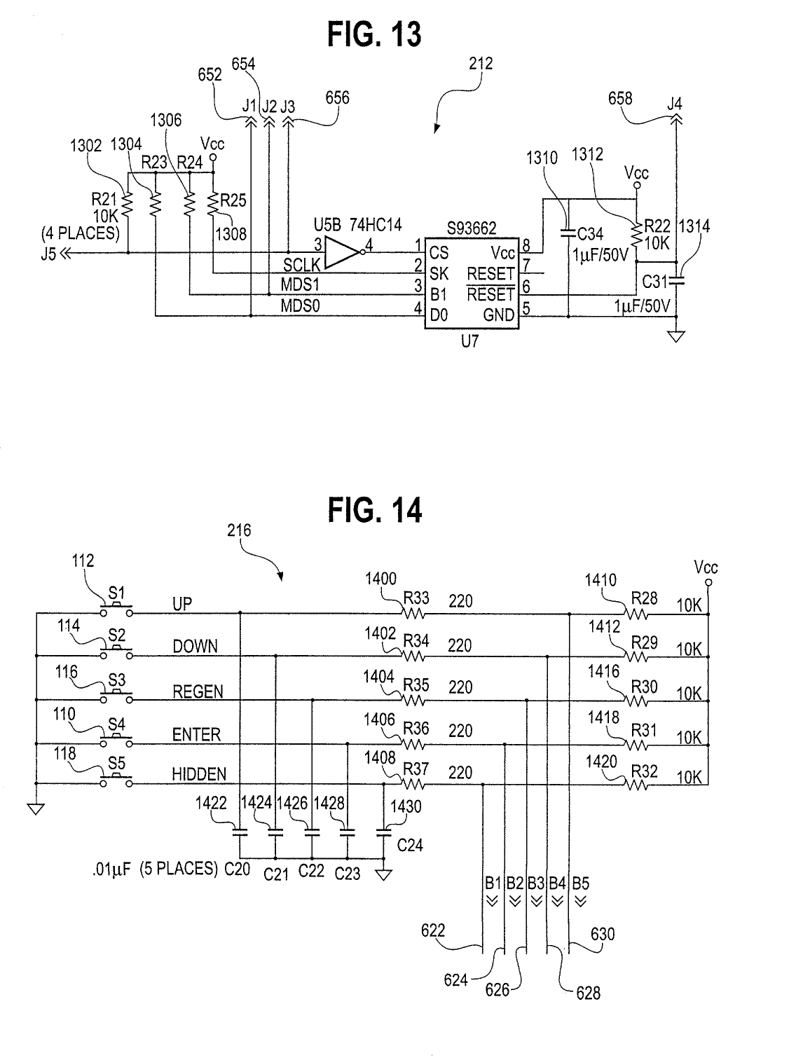

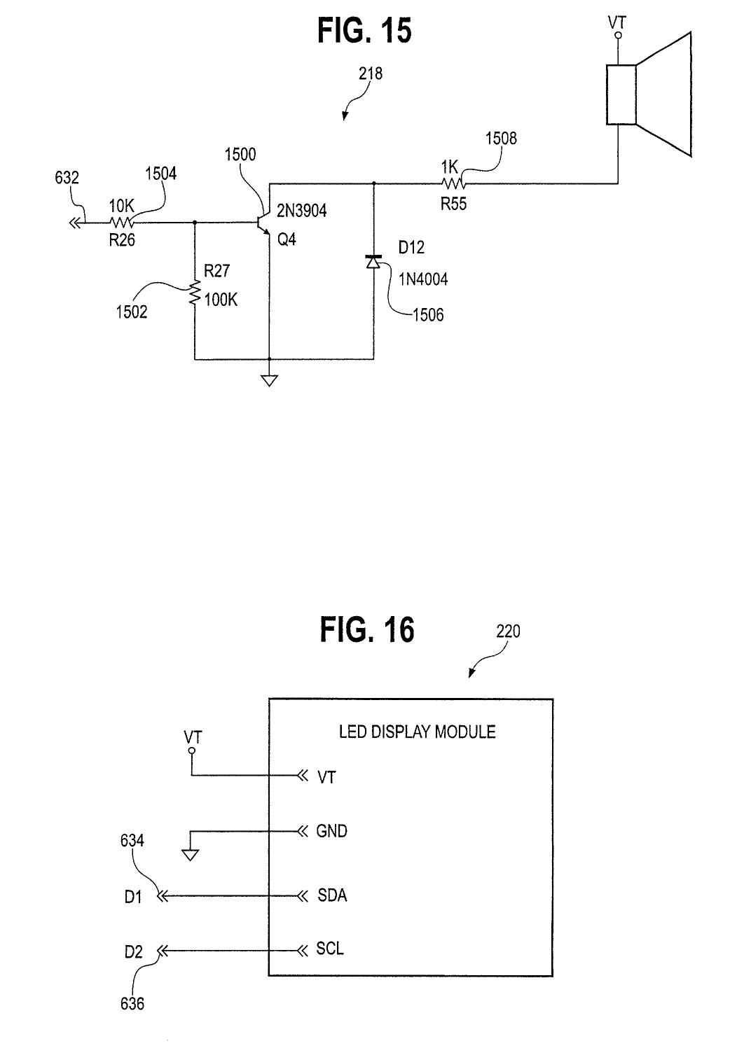

Referring now to FIG. 2, a block diagram of a water softener control circuit according to a preferred embodiment of the present invention is shown. A microcontroller 200 (including support circuitry, described in more detail with respect to FIG. 6) accepts input from a flow meter interface circuit 202 (described in more detail with respect to FIG. 7), a valve motor position feedback circuit 204 (described in more detail with respect to FIG. 9), a real-time clock calendar circuit 206 (described in more detail with respect to FIG. 8), a power supply circuit 208 (described in more detail with respect to FIG. 11), a nonvolatile memory circuit 212 (described in more detail with respect to FIG. 13), a power line synchronization circuit 214 (described in more detail with respect to FIG. 12), and a keypad and interface circuit 216 (described in more detail with respect to FIG. 14). The microcontroller 200 also supplies output to a regeneration valve motor drive circuit 210 (described in more detail with respect to FIG. 10), the nonvolatile memory circuit 212, an audio annunciator drive circuit 218 (described in more detail with respect to FIG. 15), and an LED display module 220 (described in more detail with respect to FIG. 16) that controls the LED display 120 shown on FIG. 1. The flow of information to and from the microcontroller 200 to and from the other circuit modules is described in more detail below with respect to the algorithm flowcharts (FIGS. 3-5) and the circuit diagrams (FIGS. 6-16).

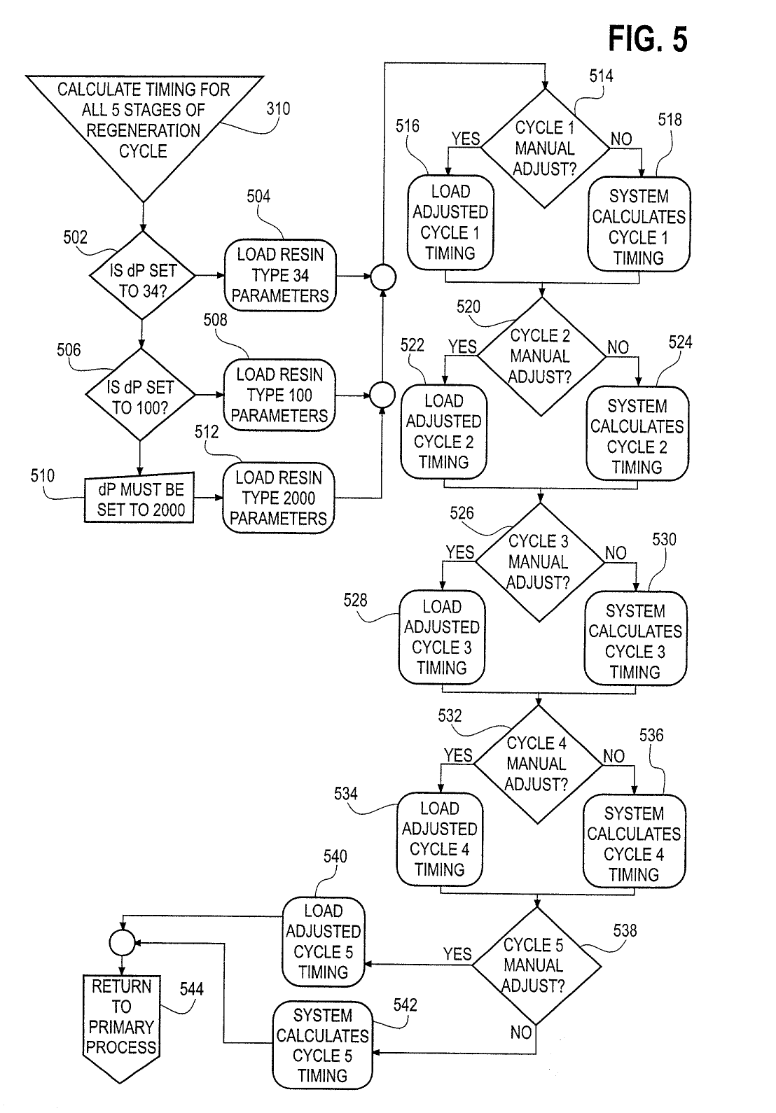

Referring now to FIG. 3, with continued reference to FIG. 2, a flow chart of the water softener control adaptive regeneration algorithm is shown. In this flow chart, parameters are entered using the keypad and interface circuit 216 shown in FIG. 2, and as is described further above with respect to FIG. 1. The inlet water hardness is entered at step 302, the default programming (resin type) is entered at step 304, the starting capacity is entered at step 306, and the tank capacity is entered at step 308. The system then calculates the timing for the five stages of the regeneration cycle at step 310. The calculation of the timing of the five stages of the regeneration cycle is discussed in more detail with respect to FIG. 5.

The system then monitors the water flow rate at step 312 using input from the flow meter at 314 received from the flow meter interface circuit 202 shown in FIG. 2. The system then the determines whether the Regeneration Override function (described above) is enabled at 316. If the Regeneration Override function is not enabled, the system determines whether the water softener tank is depleted at 318. If the water softener tank is not depleted, the system returns to step 310, which is to calculate timing for the five stages of the regeneration cycle. If the water softener tank is depleted at 318, the system executes the regeneration cycle 320.

If the system determines the Regeneration Override function is enabled at 316, the system determines whether override time has elapsed at 322 using input from the real time clock calendar circuit 206 shown in FIG. 2. If the override time has not elapsed, the system determines whether the softener tank is depleted at 318, as described above. If the system determines that the override time has elapsed, the system executes the regeneration cycle at 320.

The regeneration cycle performed at 320 utilizes the regeneration valve motor drive circuit 210, shown in FIG. 2 and described in more detail below with respect to FIG. 10, and the valve motor position feedback circuit 204, described in more detail below with respect to FIG. 9, in conjunction with the regeneration valve motor drive circuit 210. After the regeneration cycle 320 has been performed, parameters are reset at 324 (such as capacity remaining in system). These parameters are reset in the nonvolatile memory circuit 212 shown in FIG. 2 and described in more detail below with respect to FIG. 13. The number of regenerations counter is then incremented by one at 326.

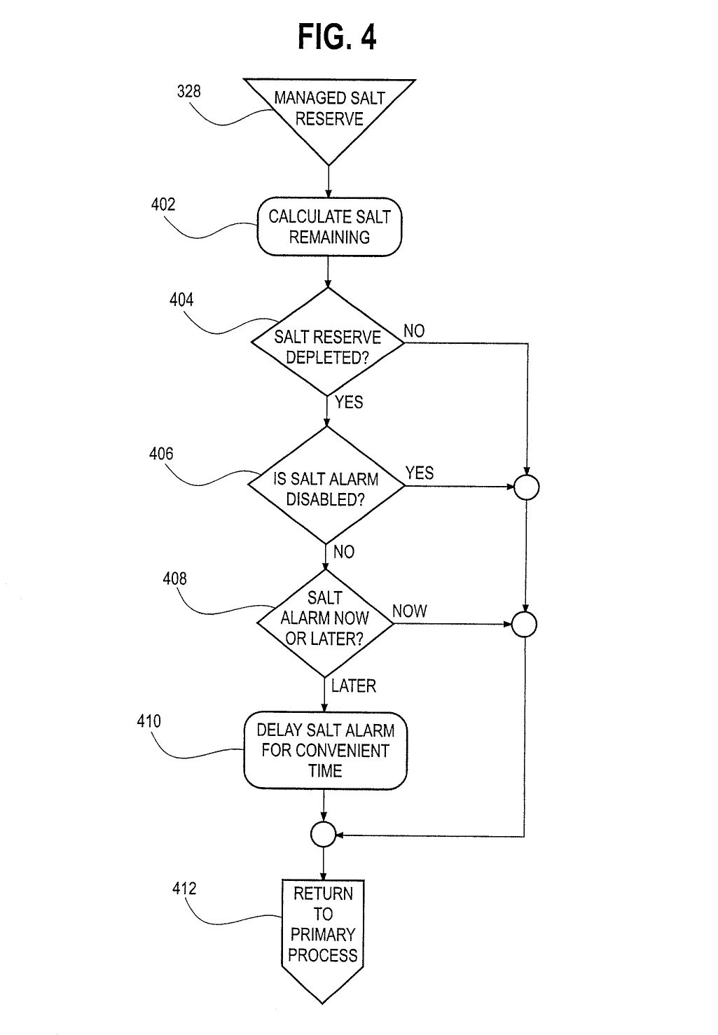

After the regeneration counter is incremented by one at 326, the system enters the manage salt reserve function at 328 Referring now to FIG. 4, with continued reference to FIG. 2, the manage salt reserve function 328 is shown in greater detail. The manage salt reserve function 328 begins with the system calculating the salt remaining in the system at 402. The system then determines whether the salt reserve has been depleted at 404. If the salt reserve has not been depleted the system returns to the primary process (shown in FIG. 3) at 412, and the system then calculates the timing for the stages of regeneration cycle at 310 in FIG. 3.

If the salt reserves have been depleted as determined at 404, the system determines whether the salt alarm is disabled at 406. If the salt alarm has been disabled, the system returns to the primary process (shown in FIG. 3) at 412, and the system then calculates the timing for the stages of regeneration cycle at 310 in FIG. 3. If the salt alarm has not been disabled as determined at 406, the system determines whether the salt alarm should sound now or at a later time at 408. If the salt alarm is to sound now, the system will sound the alarm through the audio annunciator drive circuit 218 shown in FIG. 2 and described in more detail below with respect to FIG. 15. The system then returns to the primary process (shown in FIG. 3) at 412, and calculates the timing for the stages of regeneration cycle at 310 in FIG. 3.

If the system determines that a delay has been sent and the alarm should sound at a later time, the system will delay the salt alarm until the later time set by the user at 410. The system then returns to the primary process (shown in FIG. 3) at 412, and calculates the timing for the stages of regeneration cycle at 310 in FIG. 3.

Referring now to FIG. 5, with continued reference to FIG. 2, a flow chart of the steps the system takes in calculating timing for the five stages of the regeneration cycle is shown. When the system reaches step 310 (calculate timing for five stages of regeneration cycle) shown in FIG. 3, the system determines whether the default programming resin type is set to 34 at 502. If the resin type is set to 34, the system loads resin type 34 parameters at 504 from the nonvolatile memory circuit 212 shown in FIG. 2 and described in more detail below with respect to FIG. 13. If the resin type is not set to 34 as determined at 502, the system determines whether the resin type is set to 100 at 506. If the resin type is set to 100, the system loads resin type 100 parameters at 508 from the nonvolatile memory circuit 212. If the resin type is not set to 100 as determined at 506, the system determines that the resin type is set to 2000 at 510. The system then loads resin type of 2000 parameters at 512 from the nonvolatile memory circuit 212.

After the resin type parameters have been loaded from the nonvolatile memory 212 at step 504, 508, or 512, the system determines whether cycle 1 has been manually adjusted at 514. If cycle 1 timing has been manually adjusted, the system loads adjusted cycle 1 timing from nonvolatile memory circuit 212 at step 516 . If cycle 1 has not been manually adjusted, the system calculates the cycle 1 timing at step 518 using the parameters retrieved from the nonvolatile memory circuit 212 as described above.

After the cycle 1 timing has either been loaded at step 516 or calculated at step 518, the system determines whether cycle 2 timing has been manually adjusted at step 520. If cycle 2 timing has been manually adjusted, the system loads adjusted cycle 2 timing from nonvolatile memory circuit 212 at step 522. If cycle 2 has not been manually adjusted, the system calculates the cycle 2 timing at step 524 using the parameters retrieved from the nonvolatile memory circuit 212 as described above.

After the cycle 2 timing has either been loaded at step 522 or calculated at step 524, the system determines whether cycle 3 timing has been manually adjusted at step 526. If cycle 3 timing has been manually adjusted, the system loads adjusted cycle 3 timing from nonvolatile memory circuit 212 at step 528. If cycle 3 has not been manually adjusted, the system calculates the cycle 3 timing at step 530 using the parameters retrieved from the nonvolatile memory circuit 212 as described above.

After the cycle 3 timing has either been loaded at step 528 or calculated at step 530, the system determines whether cycle 4 timing has been manually adjusted at step 532. If cycle 4 timing has been manually adjusted, the system loads adjusted cycle 4 timing from nonvolatile memory circuit 212 at step 534. If cycle 4 has not been manually adjusted, the system calculates the cycle 4 timing at step 536 using the parameters retrieved from the nonvolatile memory circuit 212 as described above.

After the cycle 4 timing has either been loaded at step 534 or calculated at step 536, the system determines whether cycle 5 timing has been manually adjusted at step 538. If cycle 5 timing has been manually adjusted, the system loads adjusted cycle 5 timing from nonvolatile memory circuit 212 at step 540. If cycle 5 has not been manually adjusted, the system calculates the cycle 5 timing at step 542 using the parameters retrieved from the nonvolatile memory circuit 212 as described above.

After the five cycle timings have been either calculated or loaded, the system returns to the primary process (shown in FIG. 3) at step 544. The system then continues as described above with respect to FIG. 3.

Referring now to FIGS. 6-16, with continued reference to FIG. 2, the modules of the water softener control circuit are described in more detail. Referring to first to FIG. 6, the microcontroller and related circuitry 200 is shown. The microcontroller integrated circuit 600 is programmed as a finite state machine that monitors sensors and other inputs, and responds to these inputs by driving output ports at the appropriate times.

The connections to these input and output ports (620 through 660) are described in more detail with respect to the subparts of the circuit illustrated and described further below. The microcontroller integrated circuit 600 also provides filtering and validation of input signals. The support circuitry for the microcontroller integrated circuit 600 includes capacitors 602, 604, and 606 which form a wide frequency and filter for the Vcc power 610 powering the microcontroller integrated circuit 600. The support circuitry for the microcontroller integrated circuit 600 also includes a high frequency crystal resonator 612, capacitors 614 and 616, and resistor 618 which together form an oscillator which provides the operating time and base for the microcontroller integrated circuit 600. Certain unused input/output ports on the microcontroller integrated circuit 600 are connected to Vcc power 610 via a 10,000 ohm resistor as shown in FIG. 6, which prevents the unused ports from becoming noise sources to the microcontroller integrated circuit 600.

Referring now to FIG. 7, with continued reference to FIG. 2, the flow meter interface circuit 202 is shown. The flow meter consists of a Hall effect sensor (not shown) that detects a magnet mounted on a paddle wheel that spins in the water supply line that feeds water to the water softener. The flow meter interface circuit 202 provides filtering, amplification and protection for the microcontroller input port 620. The flow meter interface circuit 202 includes an external connector 700 to the flow meter sensor, a resistor 702 that asked as a signal line pull up for the open collector sensor, a capacitor 704 that serves to filter the input signal line, a resistor 706 that acts as a current limit to protect the power supply, a capacitor 708 that filters the power supply to the Hall effect sensor, a resistor 710 that provides current limiting protection, and inverting buffers 712 and 714 that provides signal gain to insure that the input signal is sufficiently strong to provide error-free detection by the microcontroller 200. The signal from the flow meter interface circuit 202 is provided to the microcontroller 200 via input line 620.

Referring now to FIG. 8, with continued reference to FIG. 2, the real time clock/calendar circuit 206 is shown. A real time clock is used for many of the water softener features such as delayed regeneration and convenient timing of the low salt alarm discussed above with respect to FIG. 1. The real time clock/calendar circuit 206 includes an integrated circuit 800 and maintains and manages the clock information. The real time clock/calendar circuit 206 further includes a low frequency crystal resonator 802 that is used to maintain the real time clock, a high density capacitor 804 that provides an energy source for the integrated circuit 800 during power interruption, resistors 806 and 808 that provided pull up voltage for signal lines, and inverted buffer 810 that provides a robust reset pulse from the microcontroller 200 via output line 646. Bi-directional serial communication occurs with the microcontroller 200 via input/output lines 642 and 644.

Its power failure to the computer control unit occurs, the real time clock/calendar circuit 206 maintains the proper time using the power from the high density capacitor 804. When power is re-established, the computer control unit will reinitialize by checking all settings and re-establishing the current time. The computer control unit will then check to see whether the water softener was performing a regeneration, ie., the computer control unit will check in the current state of the regeneration valve via the valve motor position feedback circuit 204. If the water softener was not in regeneration at the power loss, the water softener will simply go on-line when power is restored. If the unit was in regeneration at the power loss, the computer control unit will return the regeneration valve to its home state using the regeneration valve motor drive circuit 210. In the alternative, when the power is restored, if the water softener was in regeneration at power loss, the system will restart at cycle 3 of the regeneration, and will continue with the regeneration from that point. This will insure that the water softener, regardless of where it was in the regeneration process when power was lost, will finish cleaning properly when power returns.

Referring now to FIG. 9, with continued reference to FIG. 2, the valve motor position feedback circuit 204 is shown. Information about the valve motor position is supplied to the microcontroller 200 from two switches 900 and 902 via the valve motor position feedback circuit 204. Switch 900 indicates the “home” position while switch 902 provides a change of state indication representing significant points in the rotation of the valve where timed operations are performed during the regeneration process of the water softener. The valve motor position feedback circuit 204 provides filtering, amplification and protection for the microcontroller input ports 638 and 640. The valve motor position feedback circuit 204 includes resistors 904 and 906 that act as current limits to supply current for detection of the switches 900 and 902, capacitors 908 and 910 that filter the input signal line, resistors 912 and 914 that provides current limiting protection, and inverting buffers 916 and 918 that provide signal gain to insure that the output signal provided to the microcontroller 200 via input/output lines 638 and 640 is sufficiently strong to provide error-free detection by the microcontroller 200.

Referring now to FIG. 10, with continued reference to FIG. 2, the regeneration valve motor drive circuit 210 is shown. The regeneration valve motor drive circuit 210 provides control of the motor (not shown) that operates the regeneration valve. The regeneration valve motor drive circuit 210 includes an amplifier transistor 1000 that is used to provide sufficient current drive to the input of an optical coupler integrated circuit 1002. The optical coupler integrated circuit 1002 also provides isolation between the high voltage alternating current motor switching circuit and the microcontroller 200. The regeneration valve motor drive circuit 210 also includes a triac 1004 for switching the alternating current to the motor, and capacitors 1006 and 1008 used as snubber capacitors to eliminate false triggering of the triac 1004. Various motor speeds can be achieved by phase modulation of the motor drive signal and the switching of triac 1004.

Referring now to FIG. 11, with continued reference to FIG. 2, the power supply circuit 208 is shown. The power supply circuit 208 rectifies, filters and reduces the incoming high voltage alternating current into two low voltage direct current power supplies. The low voltage direct current supply output points are five volts and approximately twelve volts. The five volt supply, designated as Vcc throughout this disclosure, is used by the microcontroller 200 and all of the logic level circuits. The higher voltage direct current supply, designated as Vt throughout this disclosure, is used for the display and the audio speaker.

The power supply circuit 208 and includes a varistor 1100 that provides protection for the microcontroller 200 by limiting the voltage of the primary alternating current power source, inductors 1102 and 1104 and capacitors 1106 and 1108 which form a filter used to eliminate line noise, diodes 1110, 1112,1114 and 1116 that form a rectifier, transistor 1118, diode 1120, diodes 1122 and resistor 1120 for together which form a series pass voltage regulator acting as the first stage to reduce the incoming voltage, and capacitor 1126 that filters incoming current. The power supply circuit 208 also includes an integrated circuit 1128 that acts as a switching regulator controller in association with resistors 1130,1132 and 1134, capacitors 1136 and 1138 and inductor 1140, which together form a switching voltage regulator that continues to reduce the incoming voltage and provides the intermediate supply voltage Vt through diode 1142 and resistor 1144. The final stage of the power supply circuit 208 includes integrated circuit 1146, which reduces the voltage to Vcc in conjunction with capacitors 1150,1152 and 1154.

Referring now to FIG. 12, with continued reference to FIG. 2, the power line synchronization circuit 214 is shown. The power line synchronization circuit 214 provides a 50 Hz or a 60 Hz pulse train used by the microcontroller 200 for timing, synchronization and phase control of the valve motor control circuit 204. The power line synchronization circuit 214 includes resistors 1200, 1202 and 1204 and capacitors 1206 and 1208 which together create a filter and a voltage divider to reduce the incoming voltage, a diode 1210 that acts to clamp the incoming signal at approximately Vcc, inverting buffer amplifiers 1212 and 1214 that improve the quality of the incoming signal by converting a chopped sine wave into a square wave signal for input to the microcontroller 200 via line 650.

Referring now to FIG. 13, with continued reference to FIG. 2, the nonvolatile memory circuit 212 is shown. The nonvolatile memory circuit 212 provides two key functions in the water softener control circuit, a memory that is not affected by power outages and a microcontroller 200 reset controller. The nonvolatile memory circuit 212 and includes integrated circuit 1300 that is connected to the microcontroller 200 via a serial communication channel 652, 654 and 656. The resistors 1302,1304, 1306 and 1308 act as voltage pull up resistors for the serial communication signals. The reset controller portion of the integrated circuit 1300 monitors Vcc and manages the microcontroller reset input 658. The nonvolatile memory circuit 212 also includes capacitor 1310 that filters the Vcc power supply, resistor 1312 that acts as a voltage pull up resistor, and capacitor 1314 that filters the reset input line 658.

Referring now to FIG. 14, with continued reference to FIG. 2, the keypad switch and interface circuit 216 is shown. The keypad switch and interface circuit 216 allows the user of the water softener computer control unit to customize the software for the user's particular water conditions and the user's convenience. The keypad switch and interface circuit 216 allows user input by transmitting user key presses on up key 112, down key 114, regen key 116, enter key 110, and hidden key 118 (shown in FIG. 1) as signals that are transmitted to the microcontroller 200 via lines 622, 624, 626, 628 and 630. The keypad switch and interface circuit 216 includes current limit resistors 1400, 1402, 1404, 1406 and 1408 that protect the microcontroller 200 from potentially damaging transient signals, and signal pull up resistors 1410,1412, 1416,1418 and 1420, capacitors 1422, 1424, 1426,1428 and 1430 that filter out electrical noise before it reaches the microcontroller 200, where such noise can potentially cause malfunctions.

The microcontroller 200 and will either accept or ignore the user key presses transmitted by the keypad switch and interface circuit 216 depending on the context of the software. For example, under most operating situations, two or more simultaneous key switch closures will be ignored by the microcontroller as an invalid input. However, when the hidden key 118 is simultaneously presses with any of the other keys, certain functions are initiated as described in detail above.

Referring now to FIG. 15, with continued reference to FIG. 2, the audio annunciator drive circuit 218 is shown. In the water softener system, audible signals are used to confirm user entries, to notify the user that attention is needed with an alarm, or to alert the user of a malfunction of the water softener. The audio annunciator drive circuit 218 includes an amplifier circuit comprising a transistor 1500, a resistor 1502, and a resistor 1504. A resistor 1508 act as a current limit and a diode 1506 acts as a voltage clamp, together they protect the transistor amplifier. The signal for the audio annunciator drive circuit 218 is received from the microcontroller 200 on input/output line 632.

Referring now to FIG. 16, with continued reference to FIG. 2, the LED display module to 20 is shown. The LED display module 220 is used to control and drive the four digit LED display 120 shown in FIG. 1. This LED display 120 is the primary means of feedback to the user. The feedback shown on the LED display 120 can be in the form of numbers and letters. Data for the LED display 120 is delivered to the LED display module 220 via input/output lines 634 and 636. The LED display module 220 then drives the appropriate LED display segments. The LED display module 220 handles all timing and control signals necessary to multiplex the LED display 120.

The foregoing description of a preferred embodiment of the invention has been presented for purposes of illustration and description, and is not intended to be exhaustive or to limit the invention to the precise form disclosed. The description was selected to best explain the principles of the invention and their practical application to enable others of skill in the art to best utilize the invention in various embodiments and various modifications as are suited to the particular use contemplated. It is intended that the scope of the invention not be limited by the specification, but be defined by the claims set forth below.

What is claimed is:

1. An interface panel for a computer control unit of a water softening system comprising:
an interface panel overlay situated over the interface panel, the interface panel overlay having one or more graphical representation of keys thereon;
one or more end user buttons contained on the interface panel, each button situated below one of the graphical representations of keys on the interface panel overlay; and
at least one hidden button contained on the interface panel that is situated at a location other than below one of the graphical representations of keys on the interface panel overlay;
wherein the actuation of the one or more end user buttons allows the operation of the water softening system; and
wherein the actuation of the hidden button allows the operation of one or more computer functions that cannot be accessed unless the hidden button is actuated.

2. The invention as claimed in claim 1, wherein actuation of the hidden button in conjunction with one or more of the end user buttons allows the operation of additional computer functions.

3. The invention as claimed in claim 2, wherein at least one of the additional computer functions accessed through the actuation of the hidden key in conjunction with one or more of the end user keys comprises diagnostic functions.

4. The invention as claimed in claim 2, wherein at least one of the additional computer functions accessed through the actuation of the hidden key in conjunction with one or more of the end user keys comprises inputting initial manufacturer settings.

5. The invention as claimed in claim 2, wherein at least one of the additional computer functions accessed through the actuation of the hidden key in conjunction with one or more of the end user keys comprises altering the manufacturer settings.

6. The invention as claimed in claim 1, wherein the interface panel has a graphical representation situated over the location of the hidden button.

7. A computer control unit of a water softening system comprising:
a microcontroller;
a computer interface comprising one or more end user buttons, an alphanumeric interface., and a functional connection to the microcontroller;
a computer interface overlay situated over the computer interface, wherein the computer interface overlay has one or more graphical representation of keys thereon, each of the graphical representations of keys overlaying one of the end user buttons;
at least one hidden button contained on the computer interface that is situated at a location other than below one of the graphical representations of keys on the computer interface overlay;
wherein the actuation of the one or more end user buttons allows the operation of one or more functions by the microcontroller; and
wherein the actuation of the hidden button allows the operation of one or more functions by the microcontroller that cannot be accessed unless the hidden button is actuated.

8. The invention as claimed in claim 7, wherein actuation of the hidden button in conjunction with one or more of the end user buttons allows the operation of additional computer functions.

9. The invention as claimed in claim 8, wherein at least one of the additional computer functions accessed through the actuation of the hidden key in conjunction with one or more of the end user keys comprises diagnostic functions.

10. The invention as claimed in claim 8, wherein at least one of the additional computer functions accessed through the actuation of the hidden key in conjunction with one or more of the end user keys comprises inputting initial manufacturer settings.

11. The invention as claimed in claim 8, wherein at least one of the additional computer functions accessed through the actuation of the hidden key in conjunction with one or more of the end user keys comprises altering the manufacturer settings.

12. The invention as claimed in claim 7, wherein the alphanumeric interface displays one or more unique characters for each of the microcontroller functions being operated.

13. A control circuit for a water softening system comprising:
a microcontroller;
a flow meter operatively connected to the microcontroller and supplying information regarding the volume of flow through the water softener system;
a clock circuit operatively connected to the microcontroller and supplying information regarding the date and time;
a power supply circuit operatively connected to the microcontroller and supplying power to the water softener system;
a regeneration valve motor drive circuit operatively connected to the microcontroller and controlling a valve used in a regeneration process of the water softener system;
a nonvolatile memory circuit operatively connected to the microcontroller and storing and supplying information to the microcontroller;
a keypad and interface circuit operatively connected to the microcontroller and facilitating user input to the microcontroller;
an audio annunciator drive circuit operatively connected to the microcontroller and allowing an audio alarm to sound at certain predetermined conditions, and an LED display module operatively connected to the microcontroller that allows a user readable display.

14. The invention as claimed in claim 13, further comprising a valve motor position feedback circuit operatively connected to the microcontroller for supplying information to the microcontroller regarding the position of the regeneration valve motor.

15. The invention as claimed in claim 13, wherein the keypad and interface circuit comprises:
a computer interface having one or more end user buttons, an alphanumeric interface, and a functional connection to the microcontroller;
a computer interface overlay situated or the computer interface, wherein the computer interface overlay has one or more graphical representations of keys thereon, each of the graphical representations of keys overlaying one of the end user buttons;
at least one hidden button contained on the computer interface that is situated at a location other than below one of the graphical representations of keys on the computer interface overlay;
wherein the actuation of the one or more end user buttons allows the operation of one or more functions by the microcontroller; and
wherein the actuation of the hidden button allows the operation of one or more functions by the microcontroller that cannot be accessed unless the hidden button is actuated.

16. The invention as claimed in claim 15, wherein actuation of the hidden button in conjunction with one or more of the end user buttons allows the operation of additional computer functions.

17. The invention as claimed in claim 16, wherein at least one of the additional computer functions accessed through the actuation of the hidden key in conjunction with one or more of the end user keys comprises diagnostic functions.

18. The invention as claimed in claim 16, wherein at least one of the additional computer functions accessed through the actuation of the hidden key in conjunction with one or more of the end user keys comprises inputting initial manufacturer settings.

19. The invention as claimed in claim 16, wherein at least one of the additional computer functions accessed through the actuation of the hidden key in conjunction with one or more of the end user keys comprises altering the manufacturer settings.

20. The invention as claimed in claim 15, wherein the interface panel has a graphical representation situated directly over the location of the hidden button.
